(19) United States
(12) Patent Application Publication
(10) Pub. No.: US 2025/0035733 A1
(43) Pub. Date: Jan. 30, 2025

(54) APPARATUS AND METHOD FOR DETECTING VEHICLE KEY POSITION

(71) Applicant: HYUNDAI MOBIS CO., LTD., Seoul (KR)

(72) Inventors: Hee Su KIM, Yongin-si (KR); Gyeong Hun CHO, Yongin-si (KR); Jaekwon KIM, Yongin-si (KR)

(73) Assignee: HYUNDAI MOBIS CO., LTD., Seoul (KR)

(21) Appl. No.: 18/629,064

(22) Filed: Apr. 8, 2024

(30) Foreign Application Priority Data
Jul. 27, 2023 (KR) 10-2023-0098261

(51) Int. Cl. G01S 5/14; B60R 25/20; B60R 25/24

(52) U.S. Cl. CPC G01S 5/14; B60R 25/2072; B60R 25/245

(57) ABSTRACT

An apparatus and method for detecting a vehicle key position are provided. The apparatus includes a vehicle key including an ultra-wideband (UWB) communication-based digital key, anchors to perform UWB communication with the vehicle key, and a processor to detect a position of the digital key on the basis of the plurality of anchors.

### CROSS-REFERENCE TO RELATED APPLICATION(S)

This application claims priority from and the benefit under 35 U.S.C. § 119 to Korean Patent Application No. 10-2023-0098261, filed on Jul. 27, 2023, the disclosure of which is hereby incorporated by reference for all purposes.

### BACKGROUND

### 1. Field

The present disclosure relates to an apparatus and method for detecting a vehicle key position, and more particularly, to an apparatus and method for detecting a vehicle key position, which are capable of detecting a position of a vehicle key by using an ultra-wideband (UWB) communication.

### 2. Description of Related Art

In general, a smart key system refers to a system that enables a driver to open or close a vehicle door and start a vehicle from the outside without inserting a separate key into a key box in the vehicle or a particular manipulation for operating. The smart key system uses a FOB key or a smart key provided in the form of a card so that the driver easily carries the key.

Recently, there has been a trend using digital keys using smartphones.

Hereinafter, in the present embodiment, a vehicle key includes a digital key.

In order to use the digital key, it is necessary to detect where the digital key is positioned inside or outside the vehicle. In order to detect a position of the digital key, a distance between an antenna and the digital key is measured by using a wireless communication technology between the digital key and the antenna mounted in the vehicle, and where the digital key is positioned inside or outside the vehicle is detected on the basis of the measurement result.

However, the digital key using only near-field communication (NFC) in the related art has a problem of being hacked. Therefore, it is necessary to accurately measure a user position by using a digital key using an ultra-wideband (UWB) in order to improve security, and it is necessary to improve convenience for the user and recognize the accurate user position. Therefore, there is a need for a technology to accurately detect a position of the digital key.

The background technology related to the present disclosure is disclosed in Korean Patent Application Laid-Open No. 10-2013-0089069 (published on Aug. 9, 2013, and entitled ‘System for Searching Smart Keys for Vehicle).

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Various embodiments are directed to an apparatus and method for detecting a vehicle key position, which are capable of detecting a position of a vehicle key by using ultra-wideband (UWB) communication.

In a general aspect of the disclosure, an apparatus for detecting a vehicle key position, the apparatus includes: a vehicle key including an ultra-wideband (UWB) communication-based digital key; anchors configured to perform UWB communication with the vehicle key; and a processor configured to detect a position of the digital key based on the plurality of anchors.

The processor may be further configured to: perform, in an initialization step, coordinate setting on each of the anchors; and perform calculation of a distance between the plurality of anchors including Anchor 1 and Anchor 2, wherein a distance between the Anchor 1 and the Anchor 2 is calculated on the basis of Dxy(1,2)=\sqrt{(X1−X2)²+(Y1−Y2)²}.

The processor may be further configured to: perform, in a data acquisition step after the initialization step, receive data detected by the anchors; and perform data filtering, wherein the received data may include power (ranging power) and distance (ranging distance) information inputted from the anchors, and wherein the data filtering may be performed by using a moving window average filter or a low-pass filter (LPF).

The processor may be further configured to: perform positioning algorithm selection on the basis of the data detected by the anchors; perform anchor consistency verification after performing the positioning algorithm selection; perform cross-root calculation upon the completion of the consistency verification; perform cross-root consistency verification after performing the cross-root calculation; perform cross-root residual calculation after performing the cross-root consistency verification; and perform a process of determining a positioning coordinate when the cross-root residual calculation is performed.

The processor may be further configured to: align distance information of the anchors in ascending order; perform outdoor anchor filtering; perform positioning algorithm determination to select the positioning algorithm; align the anchors in ascending order on the basis of minimum distance (i.e., ranging distance) data; and perform filtering on the received anchor on the basis of a plurality of designated conditions to determine an outdoor anchor to be excluded from the positioning algorithm determination.

The designated conditions to determine the outdoor anchor to be excluded from the positioning algorithm determination, by performing filtering on the received anchor, may include: Condition 1: ‘reception of two or more indoor anchor data’, ‘reception of one or more outdoor anchor data’, and min (indoor anchor)<min (outdoor anchor); Condition 2: “when Pmax is not A7”, rn>2_Dxymn+rm+10 (cm) (here, rn=outdoor anchor ranging result, rm=indoor anchor ranging result, m=indoor anchor number, n=outdoor anchor number, and Pmax=maximum power value among power values); Condition 3: rn value has no cross-root with Am1 and Am2 anchors (i.e., no cross-root at least with first and second anchors in all anchor ranging according to anchor ranging result); Condition 4: rn (outdoor anchor ranging result)>(indoor anchor ranging average*2); Condition 5-1: rmax anchor positioning logic is not applied when [reception of two or more indoor+outdoor anchors], [reception of one or more outdoor anchors], and [outdoor anchor rmax−rmin>600 (cm)] are satisfied; and Condition 5-2: outdoor anchor when [reception of two or more indoor+outdoor anchors], [reception of two or more outdoor anchors], [outdoor anchor r2ndmax !=rmin], and [outdoor anchor r2ndmax−rmin>600 (cm)] are satisfied.

In a received anchor calculation step of a positioning algorithm determination step, the processor may be further configured to select the corresponding positioning algorithm on the basis of four states comprising: State 1: when the number of received anchors is 0, positioning is not performed; State 2: when the number of received anchors is 1, positioning is performed in the presence of a previous positioning coordinate result, and positioning is not formed in the absence of the previous positioning coordinate result; State 3: when the number of received anchors is 2, 2-side positioning is performed; and State 4: when the number of received anchors is 3 to 8, 3-side positioning is performed.

In the consistency verification step, the processor may be further configured to: perform indoor region consistency verification when an indoor region positioning algorithm is selected; perform trunk region consistency verification when a trunk region positioning algorithm is selected; and perform outdoor region consistency verification when an outdoor region positioning algorithm is selected.

The processor may be further configured to perform 1-side positioning or 2-side positioning depending on the number of anchors when the number of received anchors of effective data is less than three during a positioning algorithm selection and consistency verification process.

In another general embodiment of the disclosure, a method of detecting a vehicle key position includes: performing, by a processor, positioning algorithm selection on the basis of data detected by an anchor; performing, by the processor, anchor consistency verification after performing the positioning algorithm selection; performing, by the processor, cross-root calculation when the consistency verification is completed; performing, by the processor, cross-root consistency verification after performing the cross-root calculation; performing, by the processor, cross-root residual calculation after performing the cross-root consistency verification; and performing, by the processor, a process of determining a positioning coordinate when the cross-root residual calculation is performed.

In yet another general aspect of the disclosure, a processor-implemented method for detecting a vehicle key position includes providing a vehicle key including an ultra-wideband (UWB) communication-based digital key, providing a plurality of anchors configured to perform UWB communication with the vehicle key, and providing a processor configured to detect a position of the digital key by using based on the plurality of anchors.

### BRIEF DESCRIPTION OF THE DRAWINGS

FIG. 1 is an exemplified view illustrating a schematic configuration of an apparatus for detecting a vehicle key position according to an embodiment of the present disclosure.

FIG. 2 is an exemplified view illustrating a schematic position of an UWB anchor installed in a vehicle in FIG. 1.

FIG. 3 is a flowchart for explaining a method of detecting a vehicle key position according to the embodiment of the present disclosure.

FIG. 4 is an exemplified view for explaining a positioning algorithm selection process in FIG. 3.

FIG. 5 is an exemplified view for explaining a condition of a step of performing outdoor anchor filtering and explaining a processing process in FIG. 4.

FIG. 6 is an exemplified view for explaining a received anchor positioning calculation step of a positioning algorithm determination step in FIG. 4.

FIG. 7 is an exemplified view for explaining a consistency verification process of verifying a positioning calculation result after a positioning algorithm is selected in FIG. 3.

FIGS. 8A and 8B are exemplified views for explaining a relationship between consistency and whether an intersection point is present in FIG. 7.

### DETAILED DESCRIPTION

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an apparatus and method for detecting a vehicle key position will be described below with reference to the accompanying drawings through various exemplary embodiments.

Here, thicknesses of lines, sizes of constituent elements, or the like illustrated in the drawings, may be exaggerated for clarity and convenience of description. In addition, the terms used below are defined in consideration of the functions in the present disclosure and may vary depending on the intention of a user or an operator or a usual practice. Therefore, such terms should be defined based on the entire contents of the present specification.

The present embodiment relates to an apparatus and method capable of detecting a position of a vehicle key by using ultra-wideband (UWB) communication. In this case, an ultra-wideband (UWB) technology is a technology that has evolved from near-field wireless technologies in the related art such as Wi-Fi, Bluetooth, and GPS. The ultra-wideband (UWB) technology is characterized by processing, with precision of several centimeters, situation information, such as UWB anchor positions, anchor movements, and distances from other devices, that was difficult to process in the related art.

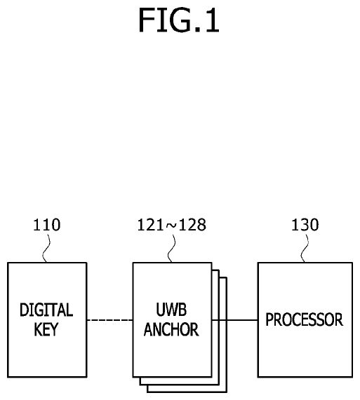

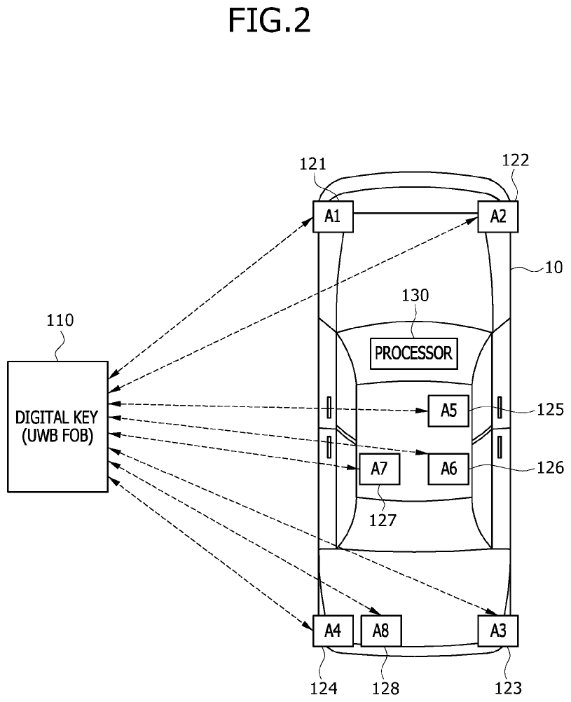

FIG. 1 is an exemplified view illustrating a schematic configuration of an apparatus for detecting a vehicle key position according to an embodiment of the present disclosure, and FIG. 2 is an exemplified view illustrating a schematic position of an UWB anchor installed in a vehicle in FIG. 1.

With reference to FIGS. 1 and 2, an apparatus for detecting a vehicle key position on the basis of UWB communication according to the present embodiment detects an accurate position of a vehicle key (including a digital key) by using bidirectional UWB (Ultra-wideband) communication.

With reference to FIG. 1, the apparatus includes a plurality of UWB anchors 121 to 128 configured to perform UWB communication with a UWB communication-based digital key 110, and a processor (e.g., ECU) 130 configured to detect a position of the digital key 110 by using the plurality of UWB anchors 121 to 128.

Hereinafter, in the present embodiment, the plurality of anchors A1 to A8 and 121 to 128 means a plurality of UWB anchors. Hereinafter, for convenience of description, the anchor and the UWB anchor will be interchangeably described, but it should be understood that the anchor and the UWB anchor have the same meaning.

The digital key 110 performs UWB communication with the plurality of anchors 121 to 128.

With reference to FIG. 2, among the plurality of anchors 121 to 128, four anchors 121, 122, 123 and 124 are respectively installed at edge portions of a vehicle.

For example, among the four anchors 121, 122, 123, and 124, two anchors 121 and 122 are respectively installed at two opposite edge portions of a front bumper, and two anchors 123 and 124 are respectively installed at two opposite edge portions of a rear bumper. In addition, one anchor 128, which is installed between the anchors 123 and 124 respectively installed at the two opposite edge portions of the rear bumper, is installed to be closer to the anchor 124 installed at one edge portion.

Among the plurality of anchors 121 to 128, the remaining three anchors 125, 126, and 127 are installed in the vehicle.

In this case, in the present embodiment, the example is described in which eight anchors 121 to 128 are installed in the vehicle. However, the number of anchors and installation positions of the anchors may vary depending on vehicle models. However, the present disclosure may be applied regardless of the number of anchors and the installation positions of the anchors.

The installation positions of the anchors 121 to 128 may be used as layout information for coping with a positioning error of the digital key 110.

In this case, the layout information includes pieces of coordinate information indicating the installation positions of the anchors, and the coordinate information means a two-dimensional coordinate.

For example, the coordinates of the UWB anchors A1 to A8 may be expressed as A1=Anchor 1=coordinates (x1, y1) to An=Anchor n=coordinates (xn, yn), and reference coordinates (see anchor coordinates) may be X-axis: center of vehicle=100 cm and Y-axis: rearmost end of vehicle=0 cm.

The plurality of anchors 121 to 128 performs the UWB communication with the digital key 110 in response to a communication instruction from the processor (e.g., ECU) 130.

The plurality of anchors 121 to 128 may be connected through a communication bus (e.g., controller area network (CAN)), which is provided in the vehicle, in order to receive the communication instruction from the processor 130.

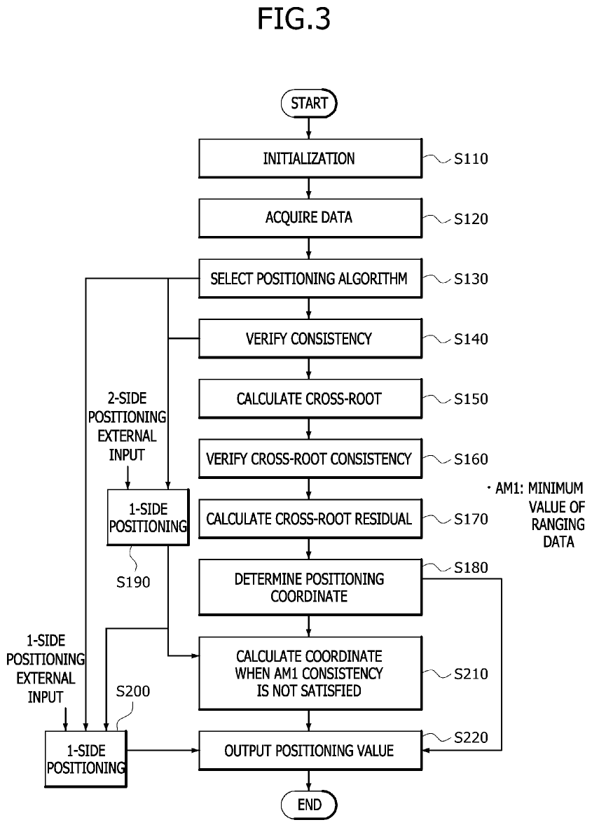

The processor 130 performs processes illustrated in FIG. 3 and detects a position of the digital key 110, e.g., where the digital key 110 is positioned inside or outside the vehicle.

FIG. 3 is a flowchart for explaining a method of detecting a vehicle key position according to the embodiment of the present disclosure.

With reference to FIG. 3, in an initialization step S110, the processor 130 may perform UWB anchor coordinate setting (i.e., read distances from the anchors installed in accordance with the type of vehicle) and anchor distance calculation (i.e., calculate distances D between the anchors mounted in the vehicle).

For example, a distance between Anchor 1 and Anchor 2 may be calculated as Dxy(1,2)=\sqrt{(X1−X2)+(Y1−Y2)²}, and a distance between Anchor 7 and Anchor 8 may be calculated as Dxy(7,8)=\sqrt{(X7−X8)+(Y7−Y8)²}. The distances D between the other anchors may be calculated in the same way.

In a data acquisition step S120, the processor 130 may receive data (i.e., data detected by the anchors) and perform data filtering.

For example, the data (i.e., data detected by the anchors) may include power (ranging power) inputted from the anchors 121 to 128 and distances (ranging distances).

In this case, the distances (ranging distances) are expressed as Anchor 1 (A1) ranging result=r1 to Anchor 8 (A8) ranging result=r8.

In addition, in case that a ranging offset is applied, Ranging=Ranging*1+9 (cm) (i.e., offset value).

In addition, power (ranging power) is expressed as Anchor 1 (A1) power result=p1 to Anchor 8 (A8) power result=p8.

In addition, the data filtering may be performed by using a Moving Window Avg. filter, and a low-pass filter (LPF) may be used.

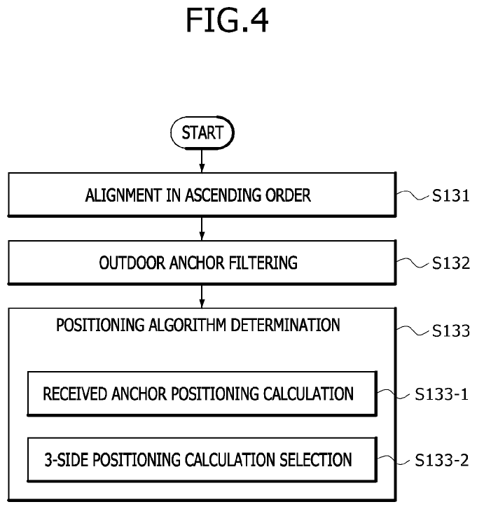

FIG. 4 is an exemplified view for explaining a positioning algorithm selection process in FIG. 3.

In a positioning algorithm selection step S130, the processor 130 aligns the distance information in ascending order (S131 in FIG. 4), performs outdoor anchor filtering (S132 in FIG. 4), and performs positioning algorithm determination (S133 in FIG. 4).

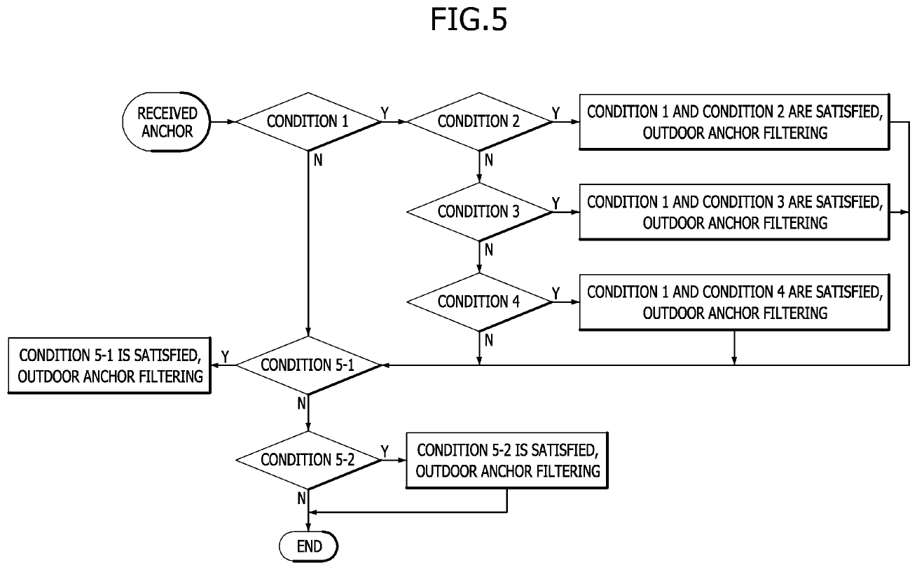

For example, the processor 130 aligns the anchors in ascending order on the basis of minimum distance (i.e., ranging distance) data (e.g., Am1, Am2, Am3, and Am4 to Am8). In addition, in step S132, the processor 130 determines the outdoor anchor, which is to be excluded, by performing filtering on the basis of the following conditions (i.e., Condition 1 to Condition 5-2 in FIG. 5).

In this case, the excluded outdoor anchor does not perform the positioning algorithm determination.

In this case, Am1 means a minimum value of the distance (ranging or range) data of the corresponding anchor.

FIG. 5 is an exemplified view for explaining a condition of a step of performing outdoor anchor filtering and explaining a processing process in FIG. 4.

Condition 1: ‘reception of two or more indoor anchor data’ and ‘reception of one or more outdoor anchor data’ and min (indoor anchor)<min (outdoor anchor).

Condition 2: “when Pmax is not A7”, rn>2_Dxymn+rm+10 (cm).

In this case, rn=outdoor anchor ranging result, rm=indoor anchor ranging result, m=indoor anchor number, n=outdoor anchor number, and Pmax=a maximum power value among power values.

Condition 3: rn value has no cross-root with Am1 and Am2 anchors (i.e., no cross-root at least with first and second anchors in all anchor ranging according to anchor ranging result).

Condition 4: rn (outdoor anchor ranging result)>(indoor anchor ranging average*2).

Condition 5-1: rmax anchor positioning logic is not applied when [reception of two or more indoor+outdoor anchors], [reception of one or more outdoor anchors], and [outdoor anchor rmax−rmin>600 (cm)] are satisfied.

Condition 5-2: outdoor anchor when [reception of two or more indoor+outdoor anchors], [reception of two or more outdoor anchors], [outdoor anchor r2ndmax !=rmin], and [outdoor anchor r2ndmax−rmin>600 (cm)] are satisfied.

With reference to FIG. 5, the outdoor anchor filtering is performed when Condition 1 and Condition 2 are satisfied, the outdoor anchor filtering is performed when Condition 1 and Condition 3 are satisfied, the outdoor anchor filtering is performed when Condition 1 and Condition 4 are satisfied, the outdoor anchor filtering is performed when Condition 5-1 is satisfied, and the outdoor anchor filtering is performed even when Condition 5-2 is satisfied.

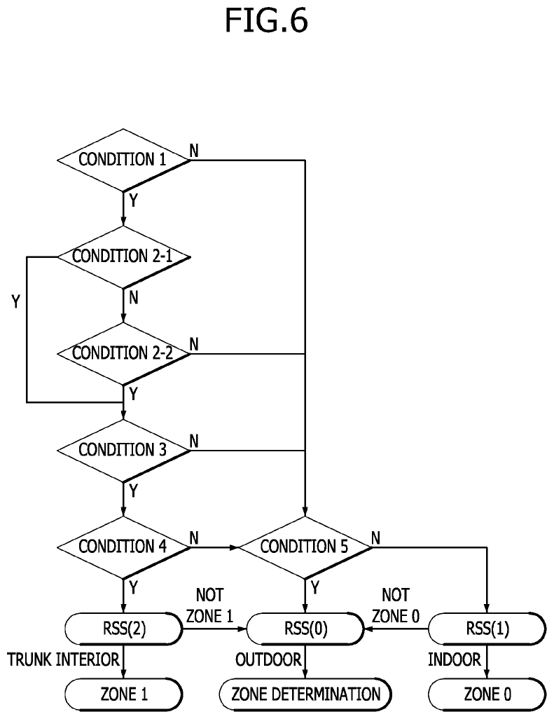

In addition, in a received anchor calculation step S133-1, the processor 130 selects the positioning algorithm in accordance with the following four types of states (see FIG. 6).

FIG. 6 is an exemplified view for explaining the received anchor positioning calculation step S133-1 of the positioning algorithm determination step S133 in FIG. 4.

State 1: when the number of received anchors is 0, positioning is not performed.

State 2: when the number of received anchors is 1, positioning is performed in the presence of the previous positioning coordinate result, and positioning is not performed in the absence of the previous positioning coordinate result.

State 3: when the number of received anchors is 2, positioning is performed on two sides (e.g., two outdoor sides, two indoor sides, or one indoor side and one outdoor side).

State 4: when the number of received anchors 3 to 8, positioning is performed on three sides (i.e., positioning algorithm RSS1, RSS2, and RSS0).

In this case, RSS1 means an indoor region, RSS2 means a trunk region, and RSS0 means an outdoor region.

With reference to FIG. 6, in State 4, the processor 130 selects the positioning algorithm on the basis of the following conditions.

RSS2 is performed when “Condition 1, (Condition 2-1 or Condition 2-2), Condition 3, and Condition 4” are satisfied, and RSS0 is performed when the outdoor side is determined after RSS2 is performed.

RSS0 is performed when “Condition 1, (Condition 2-1 or Condition 2-2), Condition 3, and Condition 4” are not satisfied and Condition 5 is satisfied, RSS1 is performed when Condition 5 is not satisfied, and RSS0 is performed when the outdoor is determined after RSS1 is performed.

In this case, Condition 1: “Am1=r3 or r4 or r6 or r7 or r8”, Condition 2-1: “{(Pm1=p3) and (p3−p8<RSS2_Offset1)} or {(Pm1=p4) and (p4−p8<RSS2_Offset1)}”, Condition 2-2: “(Pm1=p8) and {p8−avg (p3, p4)>RSS2_Offset2}”, Condition 3: “p8−avg (p6, p7)>RSS2_Offset3”, Condition 4: reception of A3 & A4 & A6 & A7 & A8, Condition 5: “reception of one or more outdoor anchors” and {(Pm1!=p8) and (Pm1=p1 or p2 or p5) and (p5−outdoor Pm1<RSS0_Offset1)} or [{(p3>p8) or (p4>p8)} and (Avg (p6, p7)−outdoor Pm1<RSS0_Offset2)]”.

In addition, in a 3-side positioning calculation selection step S133-2, the processor 130 performs positioning calculation in accordance with the number of received anchors. That is, in the case of 3-side positioning, the processor performs the selection for 3-side positioning calculation of the indoor region, the trunk region, and the outdoor region.

In addition, the processor 130 performs a consistency verification step S140 in accordance with the indoor region, the trunk region, or the outdoor region determined in step S133-2.

In a consistency verification step S140, indoor region consistency verification is performed when an indoor region positioning algorithm is selected (S141), trunk region consistency verification is performed when a trunk region positioning algorithm is selected (S142), and outdoor region consistency verification is performed when an outdoor region positioning algorithm is selected (S143).

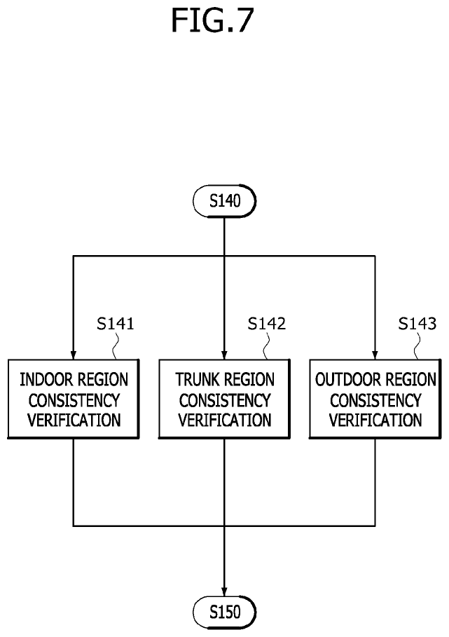

FIG. 7 is an exemplified view for explaining the consistency verification process S140 of verifying the positioning calculation result after the positioning algorithm is selected in FIG. 3.

For example, in a consistency verification step S141 for each anchor in the indoor region, the processor 130 identifies whether there is an intersection point (i.e., a range intersection point between anchors for verifying consistency).

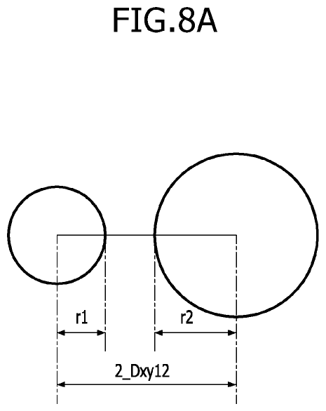

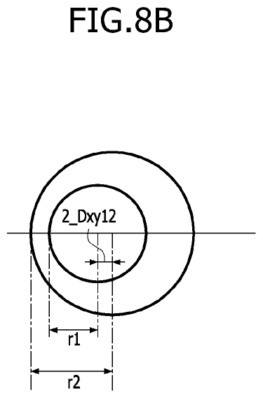

In this case, the absence of the intersection point means that there is no consistency, and this will be described more specifically with reference to FIG. 8.

(Process 0) First, r (distance) values of the anchors used for calculation are aligned in ascending order and then assigned to Am1 to Amn in order to identify whether there is an intersection point.

(Process 1) Next, when rn+1 (or 2)≥rn, a condition of “2_Dxy12+r1≥r2≥2_Dxy12−r1” is checked. In this case, rn=a range (ranging) value of an n-th anchor, and 2_Dxyab=sqrt ((Xa−Xb)\hat{ }2+(Ya−Yb)\hat{ }2).

(Process 1-1) Exceptionally, when “two indoor received anchors” & “2_Dxy12+r1<r2” are satisfied, i) RSS0 logic is performed when one or more outdoor anchors are received (RSS1 remaining logic is not performed), ii) 1-side positioning logic is performed when no outdoor anchor is received (RSS1 remaining logic is not performed).

(Process 2) Meanwhile, when there occurs any one of a case in which a condition of ‘2_Dxy12>r1+r2’ between the received indoor anchors is satisfied and a case in which consistency is not satisfied (i.e., in a case in which the anchors are not consistent with each other because all the indoor anchor distances are too short), the indoor side is determined, and the coordinate is set to an average of three indoor anchor coordinate values (logic is not performed subsequently).

(Process 3) In addition, the anchor, which does not satisfy consistency is used to calculate a residual. (Process 4) When Am1 does not satisfy consistency, Am1 is used to calculate a residual during subsequent computation, and the remains are not used. If Am1 does not satisfy consistency, coordinate calculation is performed.

In this case, Am1 means a minimum value of the distance (ranging or range) data. That is, the configuration in which a distance (ranging or range) value of a particular anchor is small means that the device (i.e., the digital key) is highly likely to be present at the corresponding position when a circle having a radius, which is a distance (ranging or range) value, is defined about a mounting position of the corresponding anchor.

FIG. 8 is an exemplified view for explaining a relationship between consistency and whether there is an intersection point in FIG. 7. FIGS. 8A and 8B are exemplified views illustrating two types of situations (Case1 and Case2) in which there is no intersection point between two circles (i.e., the range of the anchor).

As illustrated in FIG. 8A, in the case of Situation 1 (Case1) in which there is no intersection point, r2<2_Dxy12−r1 & r1+r2<2_Dxy12. In this case, r1 and r2 mean radii.

As illustrated in FIG. 8B, in the case of Situation 2 (Case2) in which there is no intersection point, 2_Dxy12+r1<r2.

Meanwhile, as illustrated in FIG. 7, in the consistency verification step S142 for each anchor in the trunk region, the processor 130 identifies whether there is an intersection point (i.e., a range intersection point between anchors for verifying consistency) (i.e., the anchors A3, A4, and A8 are used). In this case, the absence of the intersection point means that there is no consistency.

(Process 0) First, r (distance) values of the anchors (i.e., the anchors A3, A4, and A8 are used) used for trunk region consistency calculation are aligned in ascending order and then assigned to Am1 to Amn.

(Process 1) Next, Am1 and Am2 are corrected when the anchor corresponding to Am1 and the anchor corresponding to Am2 do not meet together at the time of calculating RSS2. That is, when 2_Dxy12≥Am1+Am2, Am1 and Am2 are corrected by using the following equations and then applied to positioning logic.

That is, comp=(2_Dxy12−Am1−Am2)*2+15 (cm). In this case, a comp maximum value is comp=2_Dxy12/2 when the calculated comp value is larger than 2_Dxy12/2.

Therefore, Am1=Am1+comp and Am2=Am2+comp.

In this case, comp means a corrected value.

(Process 2) Meanwhile, when rn+1 (or 2)≥rn, a condition of “2_Dxy12+r1≥r2≥2_Dxy12−r1” is checked. The anchor, which does not satisfy consistency, is used to calculate residuals (R1, R2, and R3). When Am1 does not satisfy consistency, Am1 is used to calculate the residuals during subsequent computation, and the remains are not used. However, when Am1 does not satisfy consistency, Am1 is used for coordinate calculation.

Meanwhile, as illustrated in FIG. 7, in the consistency verification step S143 for each anchor in the outdoor region, the processor 130 identifies whether there is an intersection point (i.e., a range intersection point between anchors for verifying consistency) (i.e., all the received anchors are used). In this case, the absence of the intersection point means that there is no consistency.

(Process 0) First, r (distance) values of the anchors used for RSS0 calculation are aligned in ascending order and then assigned to Am1 to Amn.

(Process 1) Next, when rn+1 (or 2)≥rn, a condition of “2_Dxy12+r1≥r2≥2_Dxy12−r1” is checked. (Process 2) The anchor, which does not satisfy consistency, is used for residual calculation.

(Process 3) However, when Am1 does not satisfy consistency, Am1 is excluded, and then positioning coordinate computation is performed (Am1 is not applied when “anchor consistency verification S140” and “cross-root consistency verification S160” are performed, and Am1 is applied when “cross-root residual calculation S170” is performed)→final positioning coordinate computation is performed at an intersection point of Am1 after cross-root two computation using three received anchors three: Am2 and Am3→final positioning coordinate computation is performed at an intersection point of Am1 after coordinate calculation is performed on an RSS minimum point by using four or more received anchors: Am2 to Amn.

(Process 4) In addition, conditions of “reception of one indoor anchor and reception of two outdoor anchors”, “Am1 and Am2 consistency satisfaction”, and “Am1 and Am3 consistency dissatisfaction” are satisfied.

In the following corresponding equations, it is assumed that Am1 and Am2 are mounting coordinates of the anchors, and r1<r2 (here, r1=ranging value of Am1, and r2=ranging value of Am2).

Hereinafter, the cross-root calculation step S150 will be described with reference to FIG. 3.

First, root optimization is performed.

$$Am 2 ( xm 2 , ym 2 ) - Am 1 ( xm 1 , ym 1 ) = ( xm 2 - xm 1 , ym 2 - ym 1 ) , a = xm 2 - xm 1 , b = ym 2 - ym 1 , and c = a \hat{} 2 + b \hat{} 2 + rm 1 \hat{} 2 - rm 2 \hat{} 2.$$

As described below, positioning computation is performed on the basis of the root optimization computation result.

(Process 1) When x-coordinates of two anchor mounting positions are equal, i.e., a=0, (root of Pxmn is a +/−equal value, Px+=Px, Px−=−1*Px, Py=one common root), Py=(b\hat{ }2+r1\hat{ }2−r2\hat{ }2)/2b, Px=sqrt (r1\hat{ }2−Pymn\hat{ }2), Px+=Px, Px−=−1*Px, and DCm (n, n+1)=(Px+,Py), (Px−,Py).

(Process 2) Next, when y-coordinates of two anchor mounting positions are equal, i.e., b=0, (Px=one common root, root of Py is a +/−equal value, Py+=Py, Py−=−1*Px), Px=(a\hat{ }2+r1\hat{ }2−r2\hat{ }2)/2a, Py=sqrt (r1\hat{ }2−Pxmn\hat{ }2), PY+=Py, Py−=−1*Py, and DCm (n, n+1)=(Px,Py+), (Px,Py−).

(Process 3) Next, when all x-coordinates and y-coordinates of two anchor mounting positions are different, i.e., a≠0 and b≠0, (two x roots, two y roots, PX+=[a*c/b\hat{ }2+sqrt {(a*c/b\hat{ }2)\hat{ }2−4*(1+(a/b)\hat{ }2)*((c/2/b)\hat{ }2−r1\hat{ }2)}]/(2+2*(a/b)\hat{ }2), PX−=[a*c/b\hat{ }2−sqrt {(a*c/b\hat{ }2)\hat{ }2−4*(1+(a/b)\hat{ }2)*((c/2/b)\hat{ }2−r1\hat{ }2)}]/(2+2*(a/b)\hat{ }2), PY+=(−2*a*PX++c)/(2*b), PY−=(−2*a*PX−+c)/(2*b), and DCm (n, n+1)=(Px+,Py+), (Px−,Py−).

In addition, DCm (n, n+1)=(Px++a, Py++b), (Px−+a, Py−+b), Px+=Px++xm1, Py+=Py++ym1, Px−=Px−+xm1, and Py−=Py−+ym1.

Next, as illustrated in FIG. 3, in the cross-root consistency verification step S160, data are inputted, filtering is performed, and then the number of cross-roots is decreased to three or less.

In this case, whether the root is within a distance (ranging or range) of all the anchors is determined, and then only the cross-root within the distance (or range) is used.

In this case, (Pxn−xi)\hat{ }2+(Pyn−yi)\hat{ }2<=ri\hat{ }2 as a determination equation when Pxn=x-coordinate of each cross-root, and Pyn=y-coordinate of each cross-root.

Therefore, i=5, 6, 7, and 8 in the case of the indoor region, i=3, 4, 5, 6, 7, and 8 in the case of the trunk region, and i=1, 2, 3, 4, 5, 6, 7, and 8 in the case of the outdoor region need to satisfy the equation (i.e., (Pxn−xi)\hat{ }2+(Pyn−yi)\hat{ }2<=ri\hat{ }2).

However, in the case of the anchor excluded in the previous step (i.e., outdoor anchor filtering, dissatisfaction of anchor consistency, or the like), i is the corresponding anchor.

When the number of cross-roots (or intersection points) exceeds three, the equation (i.e.,—distance calculation between cross-roots: Pmn distance=sqrt ((Pxm−Pxn)\hat{ }2+(Pym−Pyn)\hat{ }2)) is performed to set the number of cross-roots to three. When the number of cross-roots is three or less, the residual calculation is immediately performed, and a process of obtaining an average of two cross-roots (x, y) having a smallest distance between the cross-roots after the calculation of the distance between the cross-roots and converting the average into one cross-root is performed repeatedly until the number of cross-roots becomes three or less.

Next, as illustrated in FIG. 3, in the cross-root residual calculation step S170, the anchors used for anchor consistency and the residuals of the all the roots, which satisfy consistency, are calculated.

Pxn=x-coordinate of each cross-root that satisfies consistency.

Pyn=y-coordinate of each cross-root that satisfies consistency.

Xi=x-coordinate of i anchor mounting position.

Yi=y-coordinate of i anchor mounting position.

ri=i anchor distance (ranging or range) value.

i=5, 6, 7, and 8 in the case of the indoor region, i=3, 4, 5, 6, 7, and 8 in the case of the trunk region, and i=1, 2, 3, 4, 5, 6, 7, and 8 in the case of the outdoor region need to satisfy the equation (i.e., (Pxn−xi)\hat{ }2+(Pyn−yi)\hat{ }2<=ri\hat{ }2).

However, in the case of the anchor excluded in the previous step (outdoor anchor filtering, dissatisfaction of anchor consistency, or the like), the corresponding anchor is excluded from i in Cases 1 to 3.

(Process of 1) When Am1 consistency is not satisfied, ri->am1 range, Xi->am1 mounting x-coordinate, and Yi->am1 mounting y-coordinate are substituted and included in the residual after calculation.

$${\sum }_{i = a} ( {r}_{i} - \sqrt{{{( {P}_{xn} - {X}_{i} )}^{2} + {( {P}_{yn} - {Y}_{i} )}^{2} )}^{2}}$$

(Process 2) When the previous coordinate is maintained, the coordinate is calculated on the basis of the following equation and included in the residual.

$${( {P}_{xn} - {X}_{j} )}^{2} + {( {P}_{yn} - {Y}_{i} )}^{2}$$

In this case, the residual is expressed as R.

Next, a positioning coordinate determination step S180 will be described with reference to FIG. 3.

(Process 1) When the number of cross-roots satisfying consistency is 2,

$$Pxn = ( Px 1 * R 2 + Px 2 * R 1 ) / ( R 1 + R 2 ) / ( n - 1 ) , and$$

$$Pyn = ( Py 1 * R 2 + Py 2 * R 1 ) / ( R 1 + R 2 ) / ( n - 1 ) .$$

(Process 2) When the number of cross-roots satisfying consistency is 3,

$$Pxn = \{ Px 1 * ( R 2 + R 3 ) + Px 2 * ( R 1 + R 3 ) + Px 3 * ( R 1 + R 2 ) \} / ( R 1 + R 2 + R 3 ) / ( n - 1 ) , and$$

$$Pyn = \{ Py 1 * ( R 2 + R 3 ) + Py 2 * ( R 1 + R 3 ) + Py 3 * ( R 1 + R 2 ) \} / ( R 1 + R 2 + R 3 ) / ( n - 1 ) .$$

Next, a 2-side positioning step S190 will be described with reference to FIG. 3.

First, the anchor to be used for positioning is selected.

In this case, the previous coordinate data are maintained until the positioning coordinates are newly updated.

In this case, an entering condition is reception of two anchor distance (ranging or range) data.

Next, consistency verification for each anchor is performed.

In this case, positioning is performed when rn1+rn2≥2_D12 is satisfied.

In this case, in the case of dissatisfaction (no two anchor cross-roots), 1-side positioning using the rmin anchor is performed.

In addition, a final coordinate of two roots is selected. The root, which is a max y-coordinate is selected in the case of A1&A2, and the root, which is a min y-coordinate is selected in the case of A3&A4.

Meanwhile, when an external signal is inputted, the root is selected, as described below.

(Process 1) In the case of Door Handle Left side signal input (Toggle Touch detected, Door open/close state): the root having a small x-coordinate is selected from the two cross-roots→there is a high likelihood that the device is present at the vehicle left side.

(Process 2) In the case of Door Handle Right side signal input (Toggle Touch detected, Door open/close state): the root having a large x-coordinate is selected from the two cross-roots→there is a high likelihood that the device is present at the vehicle right side.

(Process 3) In the case of SSB input signal or Owner pairing: average value of two cross-root coordinates→there is a high likelihood that the device is present indoors.

Next, a 1-side positioning step S200 will be described with reference to FIG. 3.

(Process 1) Reception of Anchor 1: X-axis=RSS1 boundary xl−45 (cm)

$$Y - axis = A 1 y - coordinate ( cm ) - r 1$$

(Process 2) Reception of Anchor 2: X-axis=RSS1 boundary xh+45 (cm)

$$Y - axis = A 2 y - coordinate ( cm ) - r 2$$

(Process 3) Reception of Anchor 3: X-axis=RSS1 boundary xh+45 (cm)

$$Y - axis = A 3 y - coordinate ( cm ) + r 3$$

(Process 4) Reception of Anchor 4: X-axis=RSS1 boundary xl−45 (cm)

$$Y - axis = A 4 y - coordinate ( cm ) + r 4$$

In this case, 45 (cm) means, but not limited to, an offset value.

Meanwhile, when there is an external input, the process is performed, as described below.

When the Door handle signal is inputted,

in the case of the x-coordinate,

Am1 is the vehicle left side (FL, RL)→coordinate calculation is performed on a vehicle left boundary.

Am1 is the vehicle right side (FR, RR)→coordinate calculation is performed on a vehicle right boundary.

In the case of the y-coordinate,

Am1 is the vehicle front side (FL, FR)→decreased by the distance (ranging or range) value at each mounting position.

Am1 is the vehicle rear side (RL, RR)→increased by the distance (ranging or range) value at each mounting position.

Next, a coordinate calculation step S210 with dissatisfied AM1 consistency will be described with reference to FIG. 3.

A point at which a straight line between an Am1 anchor mounting coordinate and a positioning coordinate (temporary) meets a circle of Am1 is calculated as a final coordinate: an intersection point closer to the positioning coordinate (temporary) is selected from the two intersection points.

First, a straight line equation is established.

$$\cdot Am 1 ( x , y ) = Am 1 \_x , Am 1 \_y = anchor coordinate$$

$$\cdot P ( x , y ) = P\_x , P\_y = positioning coordinate ( temporary )$$

The coordinate is found by moving the anchor coordinate to 0 and then corrected, Am1 (x, y)=(0, 0)/P (x, y)=(P_x−Am1_x, P_y−Am1_y)

$$•Straight line equation = y = \{ ( Am 1 \_y - P\_y ) / ( Am 1 \_x - P\_x ) * x \}$$

$$\cdot fa = ( Am 1 \_y - P\_y ) / ( Am 1 \_x - P\_x )$$

$$\cdot fc = 0$$

$${\cdot Px}^{+} = sqrt ( rmin \hat{} 2 / ( 1 + fa \hat{} 2 ) )$$

$${\cdot Px}^{-} = - sqrt ( rmin \hat{} 2 / ( 1 + fa \hat{} 2 ) )$$

$${\cdot Py}^{+} = fa * {Px}^{+}$$

$${\cdot Py}^{-} = fa * {Px}^{-}$$

Next, Px and Py coordinates are corrected.

$${\cdot Px}^{+} = {Px}^{+} + Am 1 \_x , {Py}^{+} = {Py}^{+} + Am 1 \_y$$

$${\cdot Px}^{-} = {Px}^{-} + Am 1 \_x , {Py}^{-} = {Py}^{-} + Am 1 \_y$$

Next, an intersection point closer to P (x, y) is selected from P⁺ (x, y) and P⁻ (x, y).
A final P⁺ (x, y) coordinate is selected when a condition of {(Px⁻Px⁺)\hat{ }2+(Py⁻Py⁺)\hat{ }2}<{(Px⁻Px⁻)\hat{ }2+(Py⁻Py⁻)\hat{ }2} is satisfied, and, P⁻(x, y) is selected in the case of dissatisfaction.

When the positioning coordinate (i.e., positioning value) is determined through steps S110 to S220 as described above, the determined positioning value is outputted (S220).

According to the present embodiment described above, the position of the vehicle key may be accurately detected by using the ultra-wideband (UWB) communication, and the security may be improved by strongly coping with hacking.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An apparatus for detecting a vehicle key position, the apparatus comprising:
a vehicle key including an ultra-wideband (UWB) communication-based digital key;
a plurality of anchors configured to perform UWB communication with the vehicle key; and
a processor configured to detect a position of the digital key based on the plurality of anchors.

2. The apparatus of claim 1, wherein the processor is further configured to:
perform, in an initialization step, coordinate setting on each of the anchors; and
perform calculation of a distance between the plurality of anchors including Anchor 1 and Anchor 2,
wherein a distance between the Anchor 1 and the Anchor 2 is calculated on the basis of Dxy(1,2)=\sqrt{(X1−X2)²+(Y1−Y2)²}.

3. The apparatus of claim 1, wherein the processor is further configured to:
perform, in a data acquisition step after the initialization step, receive data detected by the anchors; and
perform data filtering,
wherein the received data include power (ranging power) and distance (ranging distance) information inputted from the anchors, and
wherein the data filtering is performed by using a moving window average filter or a low-pass filter (LPF).

4. The apparatus of claim 1, wherein the processor is further configured to:
perform positioning algorithm selection on the basis of the data detected by the anchors;
perform anchor consistency verification after performing the positioning algorithm selection;
perform cross-root calculation upon the completion of the consistency verification;
perform cross-root consistency verification after performing the cross-root calculation;
perform cross-root residual calculation after performing the cross-root consistency verification; and
perform a process of determining a positioning coordinate when the cross-root residual calculation is performed.

5. The apparatus of claim 4, wherein the processor is further configured to:
align distance information of the anchors in ascending order;
perform outdoor anchor filtering; and
perform positioning algorithm determination to select the positioning algorithm;
align the anchors in ascending order on the basis of minimum distance (i.e., ranging distance) data; and
perform filtering on the received anchor on the basis of a plurality of designated conditions to determine an outdoor anchor to be excluded from the positioning algorithm determination.

6. The apparatus of claim 5, wherein the plurality of designated conditions to determine the outdoor anchor to be excluded from the positioning algorithm determination, by performing filtering on the received anchor, comprises:
Condition 1: ‘reception of two or more indoor anchor data’, ‘reception of one or more outdoor anchor data’, and min (indoor anchor)<min (outdoor anchor);
Condition 2: “when Pmax is not A7”, rn>2_Dxymn+rm+10 (cm) (here, rn=outdoor anchor ranging result, rm=indoor anchor ranging result, m=indoor anchor number, n=outdoor anchor number, and Pmax=maximum power value among power values);
Condition 3: rn value has no cross-root with Am1 and Am2 anchors (i.e., no cross-root at least with first and second anchors in all anchor ranging according to anchor ranging result);
Condition 4: rn (outdoor anchor ranging result)>(indoor anchor ranging average*2);
Condition 5-1: rmax anchor positioning logic is not applied when [reception of two or more indoor+outdoor anchors], [reception of one or more outdoor anchors], and [outdoor anchor rmax−rmin>600 (cm)] are satisfied; and
Condition 5-2: outdoor anchor when [reception of two or more indoor+outdoor anchors], [reception of two or more outdoor anchors], [outdoor anchor r2ndmax !=rmin], and [outdoor anchor r2ndmax−rmin>600 (cm)] are satisfied.

7. The apparatus of claim 5, wherein in a received anchor calculation step of a positioning algorithm determination step, the processor is further configured to select the corresponding positioning algorithm on the basis of four states comprising:
State 1: when the number of received anchors is 0, positioning is not performed;
State 2: when the number of received anchors is 1, positioning is performed in the presence of a previous positioning coordinate result, and positioning is not formed in the absence of the previous positioning coordinate result;
State 3: when the number of received anchors is 2, 2-side positioning is performed; and
State 4: when the number of received anchors is 3 to 8, 3-side positioning is performed.

8. The apparatus of claim 4, wherein in the consistency verification step, the processor is further configured to:
perform indoor region consistency verification when an indoor region positioning algorithm is selected;
perform trunk region consistency verification when a trunk region positioning algorithm is selected; and
perform outdoor region consistency verification when an outdoor region positioning algorithm is selected.

9. The apparatus of claim 4, wherein the processor is further configured to perform 1-side positioning or 2-side positioning depending on the number of anchors when the number of received anchors of effective data is less than three during a positioning algorithm selection and consistency verification process.

10. A method of detecting a vehicle key position, the method comprising:
performing, by a processor, positioning algorithm selection on the basis of data detected by an anchor;
performing, by the processor, anchor consistency verification after performing the positioning algorithm selection;
performing, by the processor, cross-root calculation when the consistency verification is completed;
performing, by the processor, cross-root consistency verification after performing the cross-root calculation;
performing, by the processor, cross-root residual calculation after performing the cross-root consistency verification; and
performing, by the processor, a process of determining a positioning coordinate when the cross-root residual calculation is performed.

11. A processor-implemented method for detecting a vehicle key position, the method comprising:
providing a vehicle key including an ultra-wideband (UWB) communication-based digital key;
providing a plurality of anchors configured to perform UWB communication with the vehicle key; and
detecting a position of the vehicle key by using based on the plurality of anchors.

12. The method of claim 11, further comprising:
performing, in an initialization step, coordinate setting on each of the anchors; and
performing calculation of a distance between the plurality of anchors including Anchor 1 and Anchor 2,
wherein a distance between the Anchor 1 and the Anchor 2 is calculated on the basis of Dxy(1,2)=\sqrt{(X1−X2)²+(Y1−Y2)²}.

13. The method of claim 11, further comprising:
performing, in a data acquisition step after the initialization step, receive data detected by the anchors; and
performing data filtering,
wherein the received data include power (ranging power) and distance (ranging distance) information inputted from the anchors, and
wherein the data filtering is performed by using a moving window average filter or a low-pass filter (LPF).

14. The method of claim 11, further comprising:
performing positioning algorithm selection on the basis of the data detected by the anchors;
performing anchor consistency verification after performing the positioning algorithm selection;
performing cross-root calculation upon the completion of the consistency verification;
performing cross-root consistency verification after performing the cross-root calculation;
performing cross-root residual calculation after performing the cross-root consistency verification; and
performing a process of determining a positioning coordinate when the cross-root residual calculation is performed.

15. The method of claim 14, further comprising:
aligning distance information of the anchors in ascending order;
performing outdoor anchor filtering;
performing positioning algorithm determination to select the positioning algorithm;
aligning the anchors in ascending order on the basis of minimum distance (i.e., ranging distance) data; and
performing filtering on the received anchor on the basis of a plurality of designated conditions to determine an outdoor anchor to be excluded from the positioning algorithm determination.

16. The method of claim 15, wherein the plurality of designated conditions to determine the outdoor anchor to be excluded from the positioning algorithm determination, by performing filtering on the received anchor, comprises:
Condition 1: ‘reception of two or more indoor anchor data’, ‘reception of one or more outdoor anchor data’, and min (indoor anchor)<min (outdoor anchor);
Condition 2: “when Pmax is not A7”, rn>2_Dxymn+rm+10 (cm) (here, rn=outdoor anchor ranging result, rm=indoor anchor ranging result, m=indoor anchor number, n=outdoor anchor number, and Pmax=maximum power value among power values);
Condition 3: rn value has no cross-root with Am1 and Am2 anchors (i.e., no cross-root at least with first and second anchors in all anchor ranging according to anchor ranging result);
Condition 4: rn (outdoor anchor ranging result)>(indoor anchor ranging average*2);
Condition 5-1: rmax anchor positioning logic is not applied when [reception of two or more indoor+outdoor anchors], [reception of one or more outdoor anchors], and [outdoor anchor rmax−rmin>600 (cm)] are satisfied; and
Condition 5-2: outdoor anchor when [reception of two or more indoor+outdoor anchors], [reception of two or more outdoor anchors], [outdoor anchor r2ndmax !=rmin], and [outdoor anchor r2ndmax−rmin>600 (cm)] are satisfied.

17. The method of claim 15, further comprising:
in a received anchor calculation step of a positioning algorithm determination step, selecting the corresponding positioning algorithm on the basis of four states,
wherein the four states comprise:
State 1: when the number of received anchors is 0, positioning is not performed;
State 2: when the number of received anchors is 1, positioning is performed in the presence of a previous positioning coordinate result, and positioning is not formed in the absence of the previous positioning coordinate result;
State 3: when the number of received anchors is 2, 2-side positioning is performed; and
State 4: when the number of received anchors is 3 to 8, 3-side positioning is performed.

18. The method of claim 14, further comprising, in the consistency verification step:
performing indoor region consistency verification when an indoor region positioning algorithm is selected;
performing trunk region consistency verification when a trunk region positioning algorithm is selected; and
performing outdoor region consistency verification when an outdoor region positioning algorithm is selected.

19. The method of claim 14, further comprising:
performing 1-side positioning or 2-side positioning depending on the number of anchors when the number of received anchors of effective data is less than three during a positioning algorithm selection and consistency verification process.
